(19) United States
(12) Patent Application Publication
(10) Pub. No.: US 2002/0188433 A1
(43) Pub. Date: Dec. 12, 2002

(54) Generic device simulator for process control

(75) Inventors: Naveen Nama Venkatesh Prasad, Bangalore (IN); Pradeep Abraham, Bangalore (IN); Kamal Raju Venkatesh, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 09/875,560

(22) Filed: Jun. 6, 2001

(51) Int. Cl. G06F 9/44; G06F 13/10; G06F 13/12

(52) U.S. Cl. 703/21

(57) ABSTRACT

Simulation of devices coupled to a bus is provided by software components. A computer is coupled to the bus via communication adapters and executes the software components. The software components utilize network variables for communicating with other devices attached to the bus. A device component encapsulates functionality. A functionality component provides the functionality and provides a standard set of interfaces. The functionality component is specialized for each device to be simulated. A user interface component of the functionality component implements a user interface associated with the simulated device and is also specialized for each simulated device. The user interface component provides a user the ability to modify inputs for the device and cause it to exercise the functionality.

### FIELD OF THE INVENTION

This invention relates generally to the field of devices (controllers) used for process control, and more particularly pertains to software simulation of the devices used for process control.

### BACKGROUND

The process control industry uses a host of devices for the purpose of controlling the processes. Usually the process control involves a set of devices networked to communicate with each other. The communication is achieved through various communication protocols such as LON, CAN etc. For a manufacturer of devices supporting these protocols, creation of a new device is time consuming, as it involves the development of hardware and software. Manufacturers have provided hardware and software tools to assist in speeding up the development. However, there are limitations with the tools. Hardware tools have a high cost of manufacture. Developing a software program has high development costs. In addition, the software is usually embedded software. Neither hardware nor software are very flexible. They make it very difficult to make changes to the existing functionality or to add or remove features.

### SUMMARY OF THE INVENTION

Simulation of devices coupled to a bus is provided by software components. A computer is coupled to the bus via communication adapters and executes the software components. The software components utilize network messages for communicating with other devices attached to the bus.

A device component encapsulates a functionality component and a user interface component of the device being simulated. The functionality component provides the functionality and a standard set of interfaces. The functionality component is specialized for each device to be simulated. The user interface component implements a user interface associated with the simulated device and is specialized for each type of simulated device. The user interface component provides a user the ability to modify inputs for the device and cause it to exercise the functionality. It receives inputs from a user and passes them on to the functionality component. Processing of messages from the network is done in the functionality component, which sends outputs to be displayed by the user interface component.

A main application is a module that creates and controls the simulated device, such as installing and uninstalling. It interfaces with the device component using predetermined interfaces. New devices are simulated adhering to the predetermined interfaces.

In one embodiment, the computer is a personal computer. A com port is coupled to a communication adapter that in turn is coupled to a process control bus. Personal computers having multiple com ports may simulate multiple devices simultaneously. In one embodiment, an entire process control system is emulated by personal computers simulating one or more devices.

### BRIEF DESCRIPTION OF THE DRAWINGS

FIG. 1 is a block diagram of a generic software architecture for simulation of process control devices.

FIG. 2 is a block diagram of a software architecture for simulation of process control devices for use on a LON bus.

FIG. 3 is a screen shot of an interface depicting the state of four input channels and outputs of an emulated device.

FIG. 4 is a screen shot of the interface of FIG. 3 depicting the state of the four input channels and outputs when one of the values of the inputs has changed.

FIG. 5 is a screen shot of the interface of FIG. 4 depicting the state of the four input channels and outputs when tampering has occurred on a further input channel.

### DETAILED DESCRIPTION

In the following description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

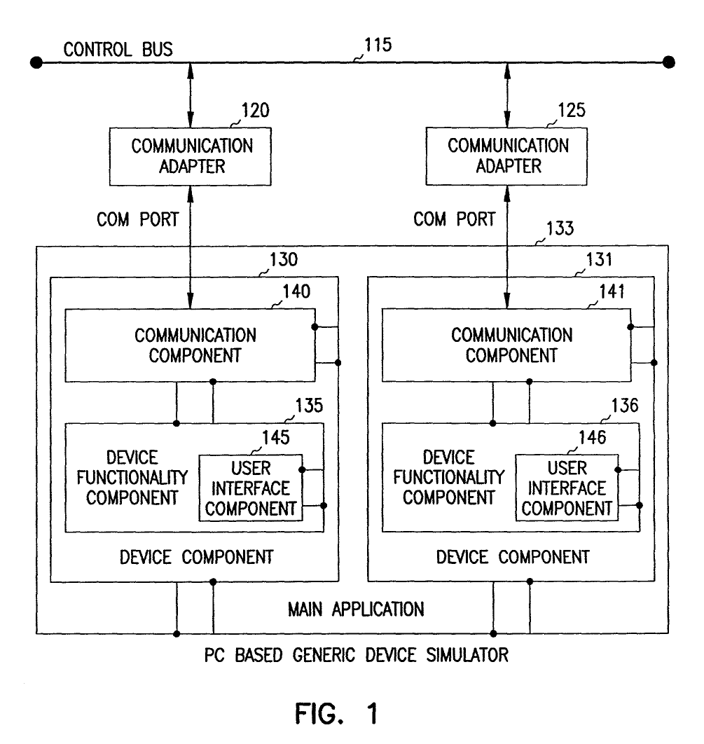

FIG. 1 is a block diagram of a generic software architecture for simulation of process control devices. A computer, such as a personal computer 110 is coupled to a control bus 115 via communication adapters 120 and 125. The personal computer 110 is a standard personal computer having input devices, a display and computer readable medium such as disk drives and random access memory for storing executable instructions. The control bus facilitates communication with a network of devices. Communication (COM) ports of the computer 110 are utilized for the connection to the communication adapters. Computer 110 executes simulation software, which simulates devices to be attached to the control bus 115. Two device components 130 and 131 are executed on personal computer 110 via a main application 133.

Each device component corresponds to a device to be simulated and is formed of multiple components. A device functionality component 135, 136 is a component that actually simulates the functions of the device. Each device component 130, 131 further comprises a communication component 140, 141 that is coupled to the communication adapters 120, 121 via COM ports. Each device functionality components 135 and 136 further includes a user interface component 145, 146 that provides a user interface, which also may vary depending on the device being simulated.

Further description of the operation of device component 130 is equally applicable to device component 131. Communication component 140 facilitates communication of the device component 130 with the rest of the devices in the network and passes messages to and from the network. This component either implements a communication protocol or includes third party software components that implement the communication protocol. The communication is done on the COM port of the PC. If the communication protocol does not use RS 232 or RS 485 physical layer, the communication adapter 120 converts the signals to the required physical layer signals.

Device component 130 encapsulates the functionality of the device and the user interface (UI) of the device, which the software is simulating. The device component contains the device functionality component 135, which implements the actual functionality of the device being simulated. This is the component that is written for each new type of device being simulated. The device functionality component has a standard set of interfaces through which the device component 130 and the communication component 140 communicate. It also encapsulates the UI component 145 because it also is specific to the device being simulated. To simulate any other device, only the device functionality component (including the UI associated to it) needs to be written, adhering to the interfaces.

UI Component 145 implements the user interface associated with the device. UI Component 145 is contained within the functionality component in one embodiment and receives inputs from a user of the computer and passes them on to the functionality component 135. The processing of the messages from the network, is performed in the functionality component 135, and outputs to be displayed to the user are sent back to the UI component 145.

Main application 133 is a module which actually creates and controls the device component, activating and deactivating the device. It provides the main UI of the simulator. The user interacts with this module. Main application 133 is not a component but is an executable program which uses all the above described components. It interacts with only the device components.

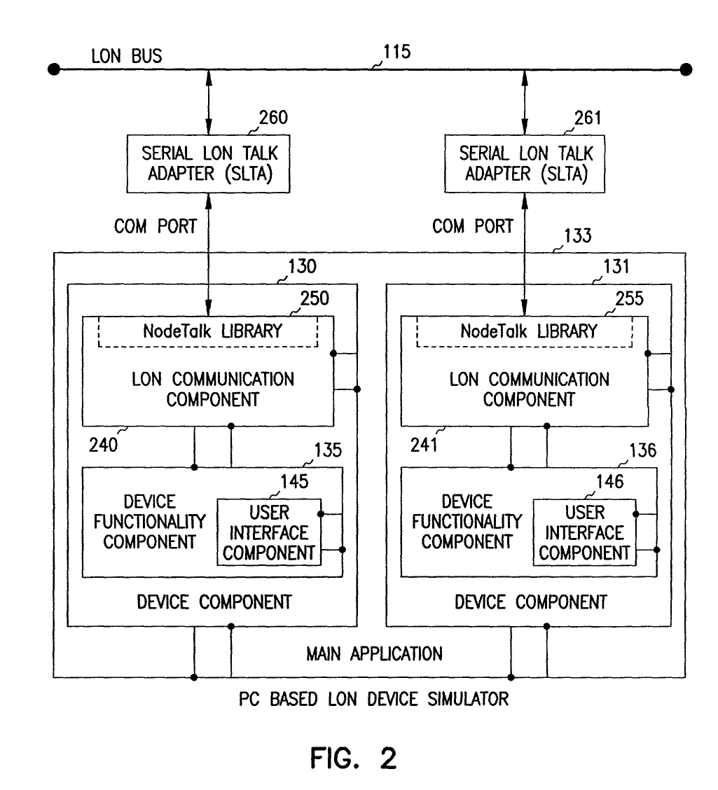

In FIG. 2, wherein the numbering of like components is the same as in FIG. 1, a Device Simulator for a LON process control bus and communication protocol is shown. In an environment consisting of devices communicating using LON protocol, communication is mostly through Network Variable updates. The Network Variables (NVs) are placeholders of information identifying states of the devices. When some state within a device changes, a NV update is triggered by an application running on the device. The update is propagated on the LON network and the addressed device/s are notified of this update. Other communication protocols are used in further environments.

In the LON based simulator, the components that are modified from FIG. 1 relate to communication components and adapters. The communication component is replaced with a LON communication component 240, 241 and a NodeTalk library 250, 255. LON communication component 240 is developed to communicate using a LON protocol. Network variables are used to pass much information as opposed to other forms of communication in the LON protocol.

NodeTalk library 250 is used for implementing the LON protocol. A Serial Lon Talk Adapter (SLTA) 260, 261 available from Echelon® Corporation is a specialized communication adapter that interfaces with the COM port of the PC. It is a device that converts signals from RS 232 to LON protocol signals. The interfaces of all the components are well defined and are frozen in one embodiment. Source for the interfaces of each component is provided in a section following a case study of the functioning of the various components in a simulation of a LON device referred to as RTU A01. The case study provides an example to give an insight into the functioning of various components of LON Device Simulator.

A centralized control environment usually consists of a central controller networked to a variety of devices. These devices may be connected to some sensors and actuators. There will be usually a constant communication between these devices and the central controller. The central controller is referred to as Central Terminal Unit (CTU) and devices as Remote Terminal Units (RTUs). This kind of centralized control environment can be used in process control industry, home and building HVAC control industry and Security based systems. There is constant communication between RTUs and CTU. The communication protocol could be anything. In this case study, it is the LON protocol in a security based system. FIG. 2 is representative of the simulation of a LON device.

The device to be simulated, RTU A01 is a LON based I/O (input/output) device. The device has 4 Analog Inputs and 4 Digital Outputs. The device application logic is usually implemented, as a set of firmware routines that continuously monitor the input levels. Any significant changes in input levels is communicated to the CTU. The CTU sends some signals to RTU, which may alter the state of outputs on the RTU.

The Inputs of the RTU A01 are usually connected to a variety of sensors or sensing instruments like magnetic card readers and outputs are connected to actuators or similar instruments. In this study, the outputs are connected to an actuator that controls a door. RTU A01 is also equipped with security features, such as tamper detection. The CTU will be promptly notified of any tampering with a RTU device such as an attempt to open the outer case of the device, tampering with circuits such as open circuit or short circuit or by-passing the power source.

Main application 133 interacts only with Lon Device component 130. LON Device component 130 exposes a few interfaces (represented by lines with heavy dots at one end) that allow the main application to switch the device on and off. It also exposes a few interfaces to query the properties of the device. With respect to Lon Device, the a few properties could be the number of NVs, the name of each of them, the Program ID of the device etc. The components are based on COM (Component Object model) which specifies interfaces in Microsoft® IDL (interface definition language).

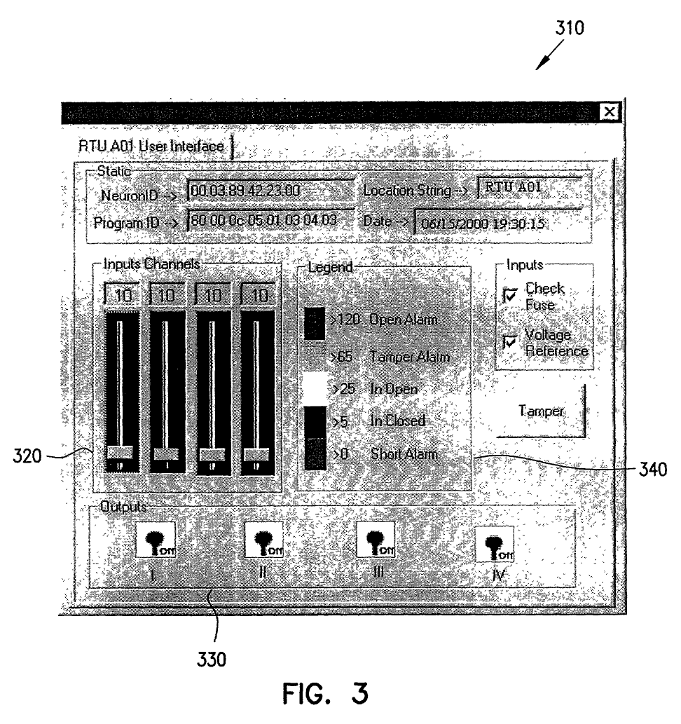

The simulation example is started with an initial state of simulated device, RTU AO1, where all the inputs are at a value 10. This translates to “In Closed” and hence all the Outputs are off. This might signify that in normal case all the doors are closed. FIG. 3 shows a screen shot of the device user interface 310 generated by user interface component 145. Input channels are represented at 320, and outputs are represented at 330. A legend represented at 340 provides an explanation of various input channel values. Other inputs, Ids, a location string identifying the device and a time and date are also provided on the user interface.

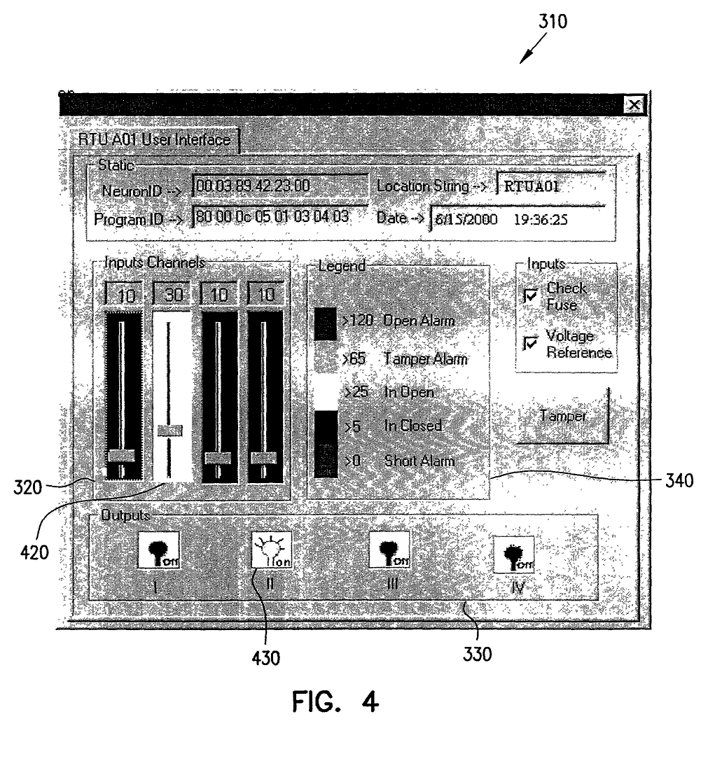

The swiping of a card by a person to gain access to a room is simulated by pulling the slider control of one of the channels such as channel 2 as shown at 420 in FIG. 4, so that it is in the “In Open” area as identified by the legend. When this is done the UI component notifies the RTUA01 Functionality component that the slider of channel 2 was pulled up and its new value is 30. Then the logic running in the RTU A01 Functionality component recognizes that this change in the Input value is significant and has to be notified to CTU. It triggers the LON communication component, which in turn creates a LON NV update packet, and fires it onto the LON network.

When the NV update reaches the CTU, it determines that a door has to be opened. Hence CTU fires a different NV Update (which is meaningful to RTU A01) on the LON network asking RTU to open the door. The LON Communication component gets this NV update and notifies the RTU A01 Functionality component about the arrival of the NV Update. The logic running in the RTU A01 Functionality component recognizes this and notifies the RTU A01 UI component that the door 2 has to be opened. Then the UI component refreshes the UI of RTU A01 to reflect this new state of output corresponding to channel 2 at 430.

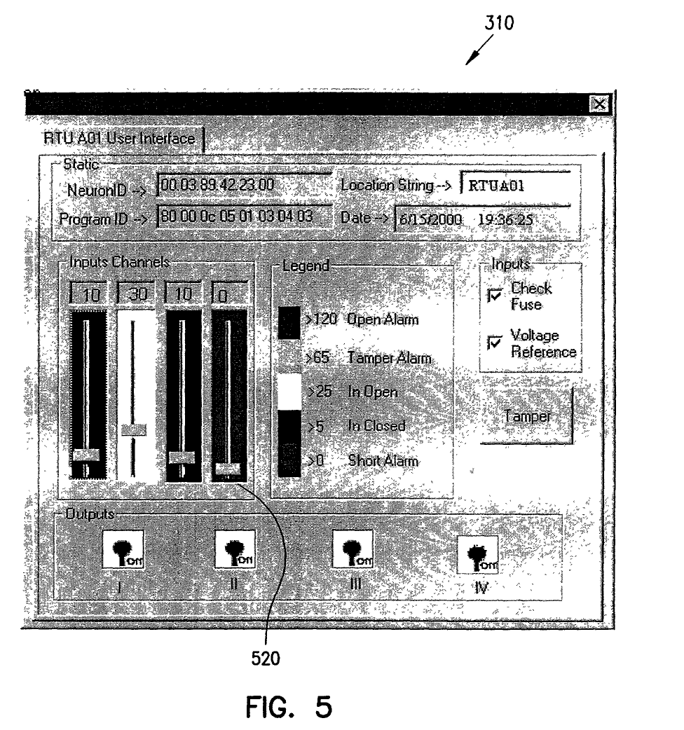

Next, simulation of an intruder trying to meddle with the security system by shorting one of the input channels say channel 4 is simulated. This can be simulated by pulling the slider control of channel 4 to 0 as indicated at 520 in FIG. 5. The RTU A01 UI component notifies this the RTU A01 Functionality component. The logic running in the functionality component immediately recognizes this and triggers the LON communication component to send the NV update to CTU to denote this situation. Finally LON Communication component fires a NV update on the LON network. When this NV update reaches the CTU, it recognizes this emergency. In response the CTU fires another NV update to RTU A01 asking it to close all the doors immediately. When LON Communication component of RTU A01 gets this NV update it notifies the RTU A01 Functionality component about the NV update. The logic running in functionality component understands this NV update and notifies the RTU A01 UI component to refresh the UI to reflect the new state, as shown by the output for channel II being “Off”.

The CTU continuously synchronizes date and time on the RTU A01 by sending NV updates periodically on the LON network. This is received by the LON Communication component. Then it notifies to RTU A01 Functionality component which will in turn notify the new time and date to the RTU A01 UI component. Then the UI is refreshed to reflect the new time and date.

The simulation of a new device is greatly simplified. All that has to be done is to implement different logic in the functionality component to reflect the behavior of the new device. The UI component is also changed to reflect the look and feel of the new device through which a human can interact.

The advantage is that, no hardware has to be manufactured to test the device before a decision on large scale production of the device is taken. Also the software development need not wait until the hardware is manufactured. In cases of destructive testing like tampering of the device (which may involve breaking open of the device chassis) it is expensive to use the actual hardware.

### Interface Specification in IDL

As previously indicated, the components are based on the COM (Component Object Model) and are specified in an interface definition language. The following specifications are for the four components of the simulator, and in particular for a LON device as used above in the case study.

[image]

[image]

[image]

[image]

[image]

[image]

[image]

[image]

[image]

[image]

[image]

[image]

[image]

[image]

[image]

[image]

[image]

[image]

[image]

[image]

### Conclusion

A software architecture has been described that provides for software simulation of the device functionality. This architecture helps in minimizing the time and effort required for the simulation of new devices. New devices can be conceived and prototyped before the actual manufacturing of hardware. This is much faster and more cost effective.

Since the simulation is personal computer based, it is more flexible than the hardware that implements the device functionality. Features can be added, removed and modified on the simulation much more easily than on prototype hardware. The simulation helps in automation of testing devices. A large number of PC based test automation tools are available. Using the automation techniques helps in achieving the robustness of the devices.

More than one device can be simulated at the same time depending on the availability of serial ports and additional generic communication hardware on the PC. This application is intended to cover any adaptations or variations of the present invention. While the invention has been described in terms of simulating process control devices, other devices may be simulated in the same manner. Further, other computers may be used to execute the components described herein. The components themselves may also be combined and/or rearranged in any manner desired. In one embodiment, a single component contains only functionality which may differ between different devices. In a further embodiment, multiple components contain the differing functionality. It should also be understood that while reference is made to components, other programming constructs may be utilized, such as modules, subroutines, in-line code, etc., that can be stored on computer readable medium and executed by the processor of a computer. It is manifestly intended that this invention be limited only by the claims and equivalents thereof.

1. A system for simulating a device to be coupled to a network bus, the system comprising:
a user interface component corresponding to the device to be simulated;
a functionality component that interacts with the user interface component and implements functions to be provided by the device to be simulated; and
a communication component coupled to the functionality component for communicating with other devices coupled to the network bus.

2. The system of claim 1 and further comprising a personal computer for executing the components.

3. The system of claim 2 and further comprising a communication adapter that couples the personal computer to the network bus.

4. The system of claim 2 and further comprising a second set of components for simulating a second device.

5. The system of claim 2 wherein the communication component is coupled to a COM port

6. The system of claim 2 wherein the user interface component generates a user interface showing the status of inputs and outputs associated with the device to be simulated.

7. The system of claim 1 and further comprising a main application that creates and controls the components simulating the device.

8. The system of claim 1 wherein communication between components is via well defined interfaces.

9. A system for simulating a device to be coupled to a network bus, the system comprising:
a computer system;
a main application running on the computer system;
a device component having interfaces for use by the main application;
a user interface component corresponding to the device to be simulated;
a functionality component that interacts with the user interface component and implements functions to be provided by the device to be simulated; and
a communication component coupled to the functionality component for communicating with other devices coupled to the network bus, wherein only the user interface component and functionality component need be modified to simulate a new type of device.

10. The system of claim 9 wherein the user interface component generates a user interface displayed on the computer system showing the status of inputs and outputs associated with the device to be simulated.

11. The system of claim 10 wherein the user interface provides visual representations for manipulation by a user to create events for the simulation of the device.

12. A method of simulating a device in a process control system by a computer system coupled to a network bus, the method comprising:
manipulating a user interface generated by a device unique user interface component to create events;
using a device generic communication component to create and send a first message representative of the event;
receiving a second message generated from another device on the network in response to the first message; and
modifying information on the user interface in response to the second message.

13. The method of claim 12 wherein the network bus comprises a LON network.

14. The method of claim 12 and further comprising simulating multiple devices on the computer system.

15. A method of creating a simulation of a device to be coupled to a network bus, the method comprising:
creating a common device component and a common communication component for multiple devices to be simulated;
modifying a device functionality component to provide functionality associated with the device to be simulated; and
executing the components on a computer coupled to the network bus.

16. The method of claim 15 and further comprising modifying a user interface component to provide a user interface associated with the device to be simulated, the user interface being displayed by the computer.

17. The method of claim 16 and further comprising modifying an additional device functionality component for use with identical versions of the common device component and a common communication component to simulate a further type of device.

18. The method of claim 17 wherein both sets of components are executed on a single computer system to simulate two different types of devices.

19. The method of claim 15, wherein the components implement COM interfaces, and wherein the COM interfaces of the common device component and common communication component are frozen.

20. A computer readable medium having instructions stored thereon for execution by a computer, the instructions causing the computer to simulate a device to be coupled to a network bus, the instructions comprising:
a user interface component corresponding to the device to be simulated;
a functionality component that interacts with the user interface component and implements functions to be provided by the device to be simulated; and
a communication component coupled to the functionality component for communicating with other devices coupled to the network bus.

21. The computer readable medium of claim 20 and further comprising a second set of components for simulating a second device.

22. The computer readable medium of claim 20 wherein the user interface component generates a user interface showing the status of inputs and outputs associated with the device to be simulated.

23. The computer readable medium of claim 20 and further comprising a main application that creates and controls the components simulating the device.

24. The computer readable medium of claim 20 wherein the components communicate with each other via interfaces.
